(19) United States
(12) Patent Application Publication
(10) Pub. No.: US 2003/0182137 A1
(43) Pub. Date: Sep. 25, 2003

(54) On-line print brokering system and method

(76) Inventors: Michael D. Whitmarsh, Vancouver, WA (US); William Hertling, Portland, OR (US)

Correspondence Address: HEWLETT-PACKARD COMPANY, Intellectual Property Administration, P.O. Box 272400, Fort Collins, CO, 80527-2400, US

(21) Appl. No.: 10/105,539

(22) Filed: Mar. 25, 2002

(51) Int. Cl. G06F 17/60

(52) U.S. Cl. 705/1

(57) ABSTRACT

An Internet-based brokering system provides a centralized collection of print jobs and placement of such jobs at on-line print service providers that are coupled to the Internet and which communicate over it. Communications between a print service provider and customers is readily provided by the Internet. In one embodiment, secure, rich-format e-mail provides communications between a print provider and a customer. In other embodiments, voice-over-IP and HTML forms are used to convey communications between the parties.

### BACKGROUND OF THE INVENTION

A person having printing needs can either fulfill the print need on his own (e.g., by using the person's own printing equipment) or engage a print provider that offers printing services and which can fulfill particular printing needs. Before contracting with a print services provider, however, a print services customer usually needs to first identify print providers that offer printing services that will fulfill the person's particular printing needs.

Identifying potential print providers that can provide specific printing services can become a time-consuming task. The print services customer must usually contact each potential print provider determine which of them might provide a specific printing service. A customer may require, for example, that a print job be completed using a particular print stock, a particular ink and/or be delivered within a certain time frame or that a print job be completed for less than a specific price. Thus, a print services customer may need to contact several potential print providers to identify which of them might provide specific printing services within the customer's parameters.

Individually contacting several potential print providers by telephone or in-person will often be inefficient. Time-consuming efforts of the customer may identify few or no print providers capable of fulfilling the print job. Accordingly, a need exists for efficiently and effectively brokering a print job between a customer and a plurality of print providers via a data network over which messages and files can be transferred. More specifically, a need exists for uniting a customer having printing needs with print providers providing print services which can fulfill the printing needs.

### BRIEF DESCRIPTION OF THE DRAWINGS

FIG. 1 is a block diagram illustrating one exemplary embodiment of a print brokering system according to the present invention.

FIG. 2 is a block diagram illustrating one exemplary embodiment of information flow through a portion of the print brokering system of FIG. 1.

FIG. 3 is a block diagram illustrating one exemplary embodiment of information flow through another portion of the print brokering system of FIG. 1.

FIG. 4 is a diagram illustrating one exemplary embodiment of a portion of a customer interface of the print brokering system of FIG. 1.

FIG. 5 is a diagram illustrating one exemplary embodiment of a portion of a print provider interface of the print brokering system of FIG. 1.

FIG. 6 is an illustration of a rich-format e-mail message input template.

FIG. 7 is an illustration of the display of a rich-format e-mail message on a computer monitor.

FIG. 8 is a flow chart of a process by which a secure, rich-format e-mail message is used to communicate between a customer and a print provider.

FIG. 9 is a block diagram of an Internet print brokering system using HTML forms to communicate between a customer and a print provider.

FIG. 10 is a flow chart of the steps of a method by which HTML forms can be used to communicate in an Internet-based print brokering system.

FIG. 11 is an illustration of an Internet print brokering system using voice over Internet to communicate between a customer and a print provider.

### DETAILED DESCRIPTION OF THE PREFERRED EMBODIMENT

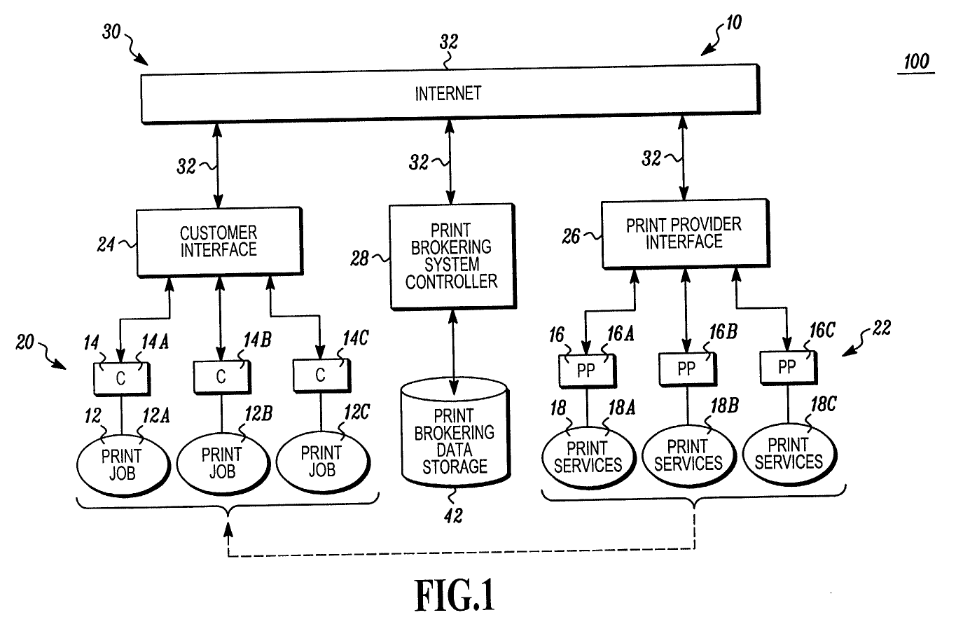

An Internet print brokering system according to the present invention is illustrated generally at 10 in FIG. 1. The Internet print brokering system 10 facilitates automatic brokering of a print job 12a, 12b, 12c of a customer 14a, 14b, 14c between one or more customers 14a, 14b, 14c and one or more print providers 16a, 16b, 16c which provide print services 18a, 18b, 18c via on-line communications. For clarity as well as simplification, print job 12a, 12b, 12c, customer 14a, 14b, 14c, print provider 16a, 16b, 16c, and print services 18a, 18b, 18c are referred to hereinafter as a print job 12, a customer 14, a print provider 16 and print services 18, respectively. As such, customer 14 may be one of a plurality of customers 20 each having one or more separate print job(s) 12. Print provider 16 may be one of a plurality of print providers 22 each providing separate print services 18. Accordingly, print brokering system 10 unites customers 20 having specific printing needs with print providers 22 which can fill those printing needs.

The term “print job” as used herein, is considered to mean, and include, any task requiring production and/or reproduction of printed matter. Examples of “print jobs” include, but are not limited to the printing and/or reproduction of documents such as catalogs, newspapers, letters, pictures, books, greeting cards, magazines, theses, essays, etc. The “fulfillment” of a print job is considered to be the provision of printed goods and/or printing services according to a customer's specifications.

A request from a customer for the fulfillment of a print job by a print provider 22 is referred to as a “print order.” A “print order” in the preferred embodiment is an electronic message, such as an e-mail message or FTP (file transfer protocol) file transfer, by which details of a print job, (e.g., print media, ink type and/or color, binding, delivery terms, quantity, etc.) are conveyed to a print provider computer 22, which is also considered to be a “print order fulfillment computer”. (In the most-general embodiment of the invention, wherein goods and services in general (i.e. not print-related) are brokered on-line, an on-line, or Internet-coupled computer which fills an order is considered to be an “order fulfillment computer.”)

A “customer” is considered herein to include an entity or entities such as a consumer, but also a business entity (corporation, partnership, sole-proprietorship) or an employee of a business entity, requesting or soliciting printing services. For simplicity, a “customer' is identified by and considered to be equivalent to its computers through which the customer communicates via a data network and which is identified by reference numeral 14. “Customer computers 14” depicted in FIG. 1, and any ancillary data transmission equipment and data network connections (which are not shown for clarity) through which print job-related information and messages are sent, are considered to be the “source” of a request for a print job to a print service provider 16.

The most general embodiment of the invention disclosed herein is not limited to the provision of on-line printing services but includes the on-line offering and/or on-line provision (e.g., by sale or lease) of any type of goods or services. For claim construction purposes, a customer's computer 12, whether the customer is seeking printing services or other, non-print-related services, is considered to be a “source” of a request for such goods or services and which are sought from an on-line provider of such goods and services 22.

“Print provider” as used herein, is considered to include an entity or entities offering, providing, and/or assisting in printing services, finishing services, delivery services, and/or other print processing services. For simplicity, a “print provider” is considered to include and is identified in the figures as the computer equipment and printers (not shown for clarity) used to fulfill print orders. Accordingly, the term “print order fulfillment computer” includes computer equipment used to either receive a print request or actually perform printing services, such as by controlling one or more printer devices.

In a more general embodiment of the invention as claimed in claim 1 and which is not limited to printing services, an “order fulfillment computer” is one or more computers that receives on-line requests for goods or services in general. Print services 18, as used herein, is defined to include printing services, finishing services, delivery services, and/or other print processing services.

In one exemplary embodiment, print brokering system 10 includes a customer interface 24, a print provider interface 26, and a print brokering system controller 28. Customer interface 24, print provider interface 26, and print brokering system controller 28 communicate with each other via a network communication link 30. Data network 30, as used herein, is defined to include the Internet and its associated communication links 32, as well as Intranets and Intranet-associated communication links, or similar high-speed synchronous (e.g., the public switched telephone network or PSTN) and asynchronous (e.g., asynchronous transfer mode or ATM) networks and communication links associated therewith. While the following description only refers to Internet communication link 32, it is understood that the use of other network communication links is within the scope of the present invention.

In one exemplary embodiment the customers 20, the print providers 22, and the print brokering system controller 28 are all remotely located from each other (i.e., at different geographic locations). Thus, communications between customers 20 and print brokering system controller 28, communications between print providers 22 and print brokering system controller 28, and communications between customers 20 and print providers 22 are conducted over the data network 30. While the print providers 22 preferably communicate with print brokering system controller 28 indirectly via Internet data/communication links 32 and the Internet network 30, it is within the scope of the present invention however for print providers 22 to communicate with print brokering system controller 28 in other manners (e.g., a direct connection).

Print brokering system 10, including print brokering system controller 28, can be implemented in hardware (e.g. using circuits such as registers, logic gates and the like) or software using via one or more microprocessors, programmable logic devices, or other finite state machine implemented with programmable instructions. The present invention may or may not use a TCP/IP protocol suite for data transport. Other usable communication protocols suitable for use with print brokering system 10 will become apparent to those skilled in the art after reading the present application.

In one preferred embodiment, print brokering system controller 28 includes a computer server or other microprocessor based system capable of performing a sequence of logic operations. In addition, print brokering system controller 28 can include a microprocessor embedded system/appliance incorporating tailored appliance hardware and/or dedicated single purpose hardware.

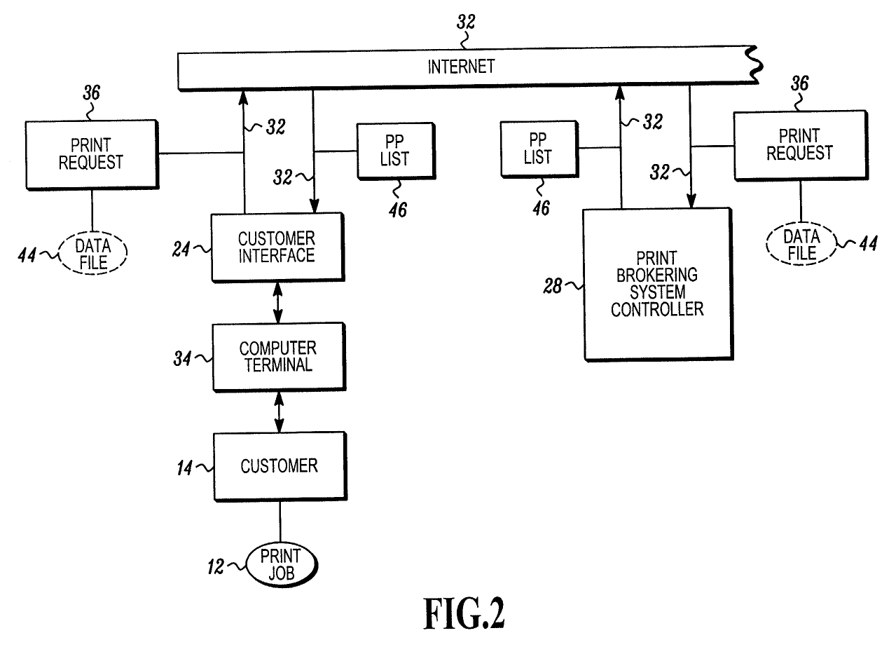

As illustrated in FIG. 2, a customer 14 can access customer interface 24 (implemented with software) of print brokering system 10 via a computer terminal 34. Computer terminal 34 includes, for example, an input device such as a keyboard and/or a mouse and a display device such as a monitor, not shown for simplicity because they are well known in the art. In one exemplary embodiment, customer 14 enters print brokering system 10 and, therefore, accesses customer interface 24 by selecting the “File/Print . . . ” command in a program running on computer terminal 34 and by selecting print brokering system 10, or an application incorporating print brokering system 10, as the “Name” of the printer. The on-line print brokering system and method can be seamlessly integrated into an application program so as to work as if a print job of an application program, (e.g., WORD™, Photoshop™) were being sent to a local printer.

Customer 14 interacts with customer interface 24 via computer terminal 34 to generate a print request 36 for print job 12 and to submit print request 36 to print brokering system controller 28 via Internet communication link 32. Print request 36 identifies attributes of print job 12 specified by customer 14, as described below. Customer 14 also interacts with customer interface 24 to register with print brokering system 10 as well as to submit billing and shipping information to print brokering system 10. Submitting billing and shipping information to print brokering system 10 includes, for example, submitting payment information such as a credit card or other account information and delivery information such as a shipping address.

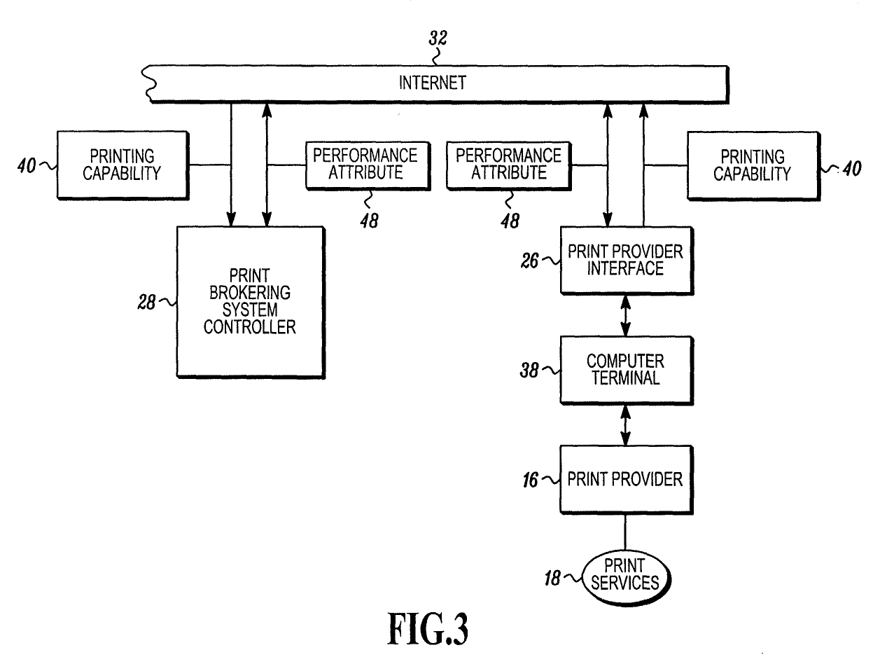

As illustrated in FIG. 3, an on-line print provider 16 accesses print provider interface 26 of print brokering system 10 via a computer terminal 38. Computer terminal 38 includes, for example, an input device such as a keyboard and/or a mouse and a display device such as a monitor (not shown) as is well known in the art.

On-line print provider 16 interacts with print provider interface 26 via computer terminal 38 to register a printing capability, typically stored within a print capability file 40 with print brokering system controller 28 via Internet communication link 32. Printing capability file 40 contains information that identifies capabilities and attributes of print services 18 provided by print provider 16, as described below. Print provider 16 also interacts with print provider interface 26 to register with print brokering system 10 as well as submit responses to queries from print brokering system 10.

In the exemplary embodiment illustrated in FIG. 1, print brokering system 10 includes a print brokering data storage system 42. Print brokering data storage system 42 constitutes a database of one or more data files for print brokering system 10. Examples of print brokering data storage system 42 include non-volatile memory (e.g., a hard disk drive or other persistent storage device) and may include volatile memory (e.g., random access memory (RAM)). Data is transferred to and from print brokering data storage system 42 via print brokering system controller 28.

Print brokering system controller 28 communicates with and transfers the printing capability 40 of print providers 22 to print brokering data storage system 42. As such, print brokering data storage system 42 stores printing capability 40 of print providers 22 for subsequent retrieval and processing. Examples of the data stored in the data storage system include, but are not limited to: customer contact data, printer drivers, font files, paper sizes and paper weights available from a particular print provider 22. More specifically, when print brokering system controller 28 receives printing capability 40 from print provider 16, printing capability 40 is stored as a data file in print brokering data storage system 42. Print brokering system controller 28, therefore, subsequently retrieves printing capability 40 from print brokering data storage system 42 for processing.

A data file 44 of print job 12 is submitted with print request 36, as illustrated in FIG. 2. Data file 44 of print job 12 is uploaded to print brokering system controller 28 via Internet communication link 32. As such, print brokering system controller 28 stores data file 44 of print job 12 in print brokering data storage system 42 for subsequent downloading to print provider 16.

When customer 14 selects print provider 16, shown in FIG. 3, to complete print job 12, print provider 16 downloads data file 44 of print job 12 from print brokering system controller 28 and, more specifically, print brokering data storage system 42 via Internet communication link 32. Thus, print job 12 is submitted to print provider 16 through print brokering system controller 28. It is, however, within the scope of the present invention for print job 12 to be submitted directly to print provider 16 from customer 14, by FTP for example.

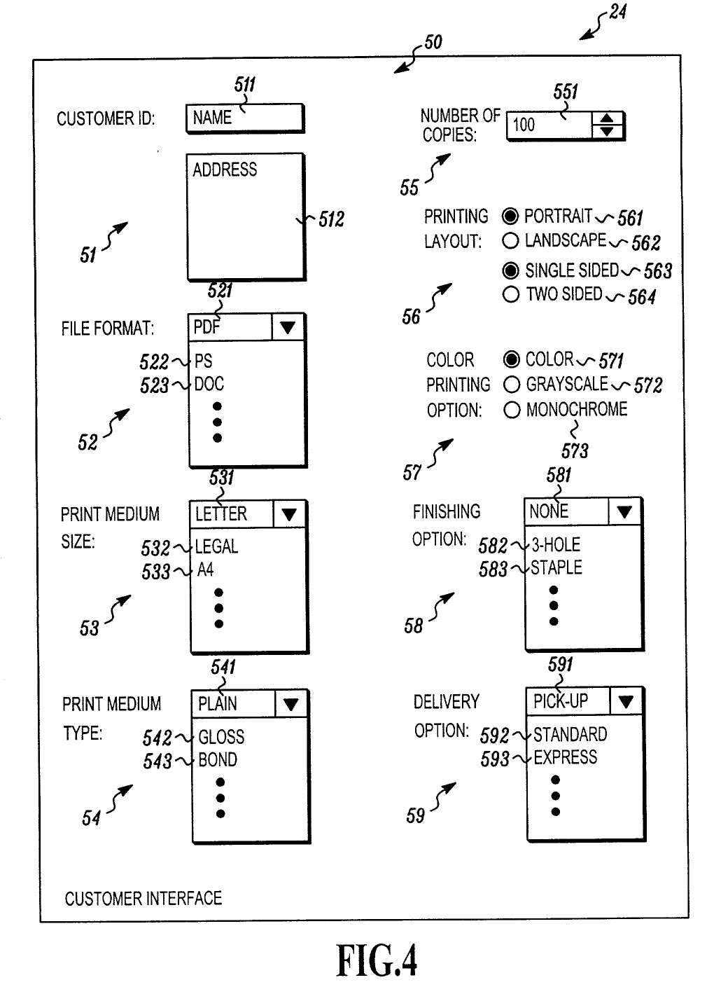

In one exemplary embodiment, as illustrated in FIG. 4, a portion of customer interface 24 (shown in FIG. 1) includes a plurality of input fields 50 with which customer 14 interacts to specify attributes of print job 12. As such, customer 14 interacts with input fields 50, via an input device such as a keyboard and/or a mouse of computer terminal 34, to generate print request 36 for print job 12. Input fields 50 include, for example, a customer identification field 51, a file format field 52, a print medium size field 53, a print medium type field 54, a number of copies field 55, a printing layout field 56, a color printing option field 57, a finishing option field 58, and a delivery option field 59. Input fields 50 each include at least one subfield providing data entry points or representing available options for generating and submitting print request 36.

Customer identification field 51 includes, for example, subfields 511 and 512 which provide data entry points for a name and an address, respectively, of customer 14. File format field 52 includes, for example, subfields 521, 522, 523 which represent different file formats for print job 12. Print medium size field 53 includes, for example, subfields 531, 532, 533 which represent different sizes of print medium for print job 12. Print medium type field 54 includes, for example, subfields 541, 542, 543 which represent different types of print medium for print job 12. Number of copies field 55 includes subfield 551 in which a number of copies included in print job 12 is specified. Printing layout field 56 includes, for example, subfields 561, 562, 563, and 564 which represent different printing layouts for print job 12. Color printing option field 57 includes, for example, subfields 571, 572, and 573 which represent different color printing options for print job 12. Finishing option field 58 includes, for example, subfields 581, 582, 583 which represent different finishing options for print job 12. Delivery option field 59 includes, for example, subfields 591, 592, 593 which represent different delivery options for print job 12.

Additional file formats, print medium sizes, print medium types, printing layouts, color printing options, finishing options, and delivery options, as are well known in the art, may be represented by additional subfields of file format field 52, print medium size field 53, print medium type field 54, printing layout field 56, color printing option field 57, finishing option field 58, and delivery option field 59, respectively. Selecting and/or completing various subfields of input fields 50, therefore, identifies attributes of print job 12 as specified by customer 14. In one exemplary embodiment, when data file 44 of print job 12 is submitted with print request 36, identification or selection of some input fields 50 of customer interface 24 are inferred from a content of data file 44, as described below. In addition, customer 14 may store preferences of various subfields as default selections.

In one illustrative embodiment of customer interface 24, subfields 521, 522, and 523 of file format field 52 represent a Portable Document Format (.PDF), a PostScript (.PS) format, and a Microsoft®) Word Document (.DOC) format, respectively. Selecting subfield 521, therefore, identifies the file from which print job 12 is to be printed as a Portable Document Format (.PDF) file. Subfields 531, 532, and 533 of print medium size field 53 represent a Letter size, a Legal size, and an A4 size of print medium, respectively. Selecting subfield 531, therefore, identifies the size of print medium upon which print job 12 is to be printed as Letter. Subfields 541, 542, and 543 of print medium type field 54 represent a Plain, a Gloss, and a Bond type of print medium, respectively. Selecting subfield 541, therefore, identifies the type of print medium upon which print job 12 is to be printed as Plain. Subfields 561, 562, 563, and 564 of printing layout field 56 represent an orientation of print job 12 including Portrait and Landscape and an imposition of print job 12 including Single-Sided and Double-Sided, respectively. Selecting subfields 561 and 563, therefore, identifies the orientation and the imposition of print job 12 as Portrait and Single-Sided, respectively. Subfields 571, 572, and 573 of color printing option field 57 represent Color Printing, Grayscale Printing, and Monochrome Printing, respectively. Selecting subfield 571, therefore, identifies Color Printing for print job 12. Subfields 581, 582, and 583 of finishing option field 58 represent No Finishing, 3-Hole Finishing, and Staple Finishing, respectively. Selecting subfield 581, therefore, identifies no finishing option for print job 12. Subfields 591, 592, and 593 of delivery option field 59 represent Pick-up, Standard Delivery, and Express Delivery, respectively. Selecting subfield 591, therefore, identifies customer pick-up of print job 12

In one exemplary embodiment, input of specific input fields 50 dictates a selection of other input fields 50. When customer 14 selects a specific subfield for example, additional subfields may appear and/or existing subfields, may be unavailable. In addition, when customer 14 selects a specific subfield, additional subfields may be automatically selected and/or completed.

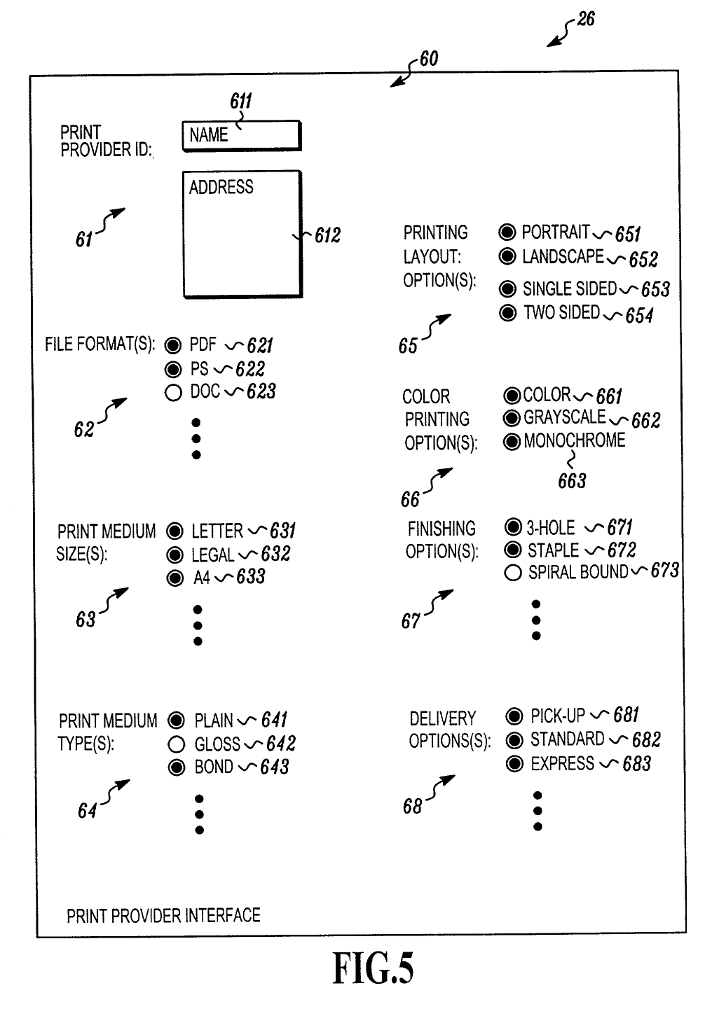

In one exemplary embodiment, as illustrated in FIG. 5, a portion of print provider interface 26 includes a plurality of input fields 60 with which print provider 16 interacts to specify attributes of print services 18. Print provider 16 interacts with input fields 60, via an input device such as a keyboard and/or a mouse of computer terminal 38, to register printing capability 40. Input fields 60 include, for example, a print provider identification field 61, a file format options field 62, a print medium size options field 63, a print medium type options field 64, a printing layout options field 65, a color printing options field 66, a finishing options field 67, and a delivery options field 68. Input fields 60 each include at least one subfield providing data entry points or representing available options for registering printing capability 40.

Print provider identification field 61 includes, for example, subfields 611 and 612 which provide data entry points for a name and an address, respectively, of print provider 16. File format options field 62 includes, for example, subfields 621, 622, 623 which represent different file formats that print provider 16 supports and, more specifically, file formats from which print provider 16 is capable of printing. Print medium size options field 63 includes, for example, subfields 631, 632, 633 which represent different sizes of print medium upon which print provider 16 is capable of printing. Print medium type options field 64, includes, for example, subfields 641, 642, 643 which represent different types of print medium upon which print provider 16 is capable of printing. Printing layout options field 65 includes, for example, subfields 651, 652, 653, and 654 which represent different printing layouts that print provider 16 is capable of providing as print services 18. Color printing options field 66 includes, for example, subfields 661, 662, and 663 which represent different color printing options that print provider 16 is capable of offering as print services 18. Finishing options field 67 includes, for example, subfields, 671, 672, 673 which represent different finishing options that print provider 16 is capable of providing as printing services 18. Delivery options field 68 includes, for example, subfields 681, 682, 683 which represent different delivery options that print provider 16 is capable of providing as print services 18.

Additional file formats, print medium sizes, print medium types, printing layout options, color printing options, finishing options, and delivery options, as are well known in the art, may be represented by additional subfields of file format options field 62, print medium size options field 63, print medium type options field 64, printing layout options field 65, color printing options field 66, finishing options field 67, and delivery options field 68, respectively. Selecting and/or completing various subfields of input fields 60, therefore, identifies attributes of print services 18 as provided by print provider 16 in a manner similar to how selecting and/or completing various subfields of input fields 50 identifies attributes of print job 12 as specified by customer 14. Print provider 16, however, may select and/or complete multiple subfields within each input field 60 to specify the different options available with print services 18.

In one exemplary embodiment, when print provider 16 selects a specific subfield, print provider 16 may also select other subfields per the specific subfield. When print provider 16 selects a specific print medium type, for example, print provider 16 may also select various print medium sizes per the specific print medium type. In addition, print provider 16 may specify or select a range of various subfields for a specific input field 60.

It is to be understood that FIGS. 4 and 5 are simplified illustrations of one exemplary embodiment of customer interface 24 and print provider interface 26, respectively. The illustrative presentation of input fields 50 and 60 including the respective subfields, for example, has been simplified for clarity of the invention. The subfields may be presented, for example, as open fields, pulldown menus, toggle selections, and/or highlighted or framed selections. In addition, customer interface 24 and/or print provider interface 26 may be presented, for example, in one or more screens or views. Furthermore, customer 14 and/or print provider 16 may generate print request 36 and register printing capability 40 by responding to query-based systems or applications. It is understood that such alternatives are within the scope of the present invention.

Notwithstanding the efficacy of an Internet print brokering system as shown in FIG. 1, in instances where a print provider 22 might require additional data or instructions from, or other communications with the customer 14, significantly improved results can be realized by using secure, rich-format electronic messages (i.e., e-mail) between the customer 14 and the print provider 22 via the data network 30 and its communication links 32.

Print jobs from customers that are to be assigned or delegated by the system controller 28 to a print provider are preferably assigned a job number or other identifier by the system controller 28 in order to track the print job and subsequent operations associated with it. Using a print job identifier, communications between a print provider 22 and the customer 14 can be directly indexed to a print job being performed by the print provider 22 for the customer 14. Every aspect of a print job, including all communications between the parties regarding the print job, can be stored (on a magnetic disk, magnetic tape or other storage media) for archival and retrieval and indexed using the print job identifier. Examples of such identifiers include, but are not limited to, a customer's name, address, phone number or taxpayer identification number, e.g. SSN. Customers to an Internet print brokering system might be assigned customer numbers as well.

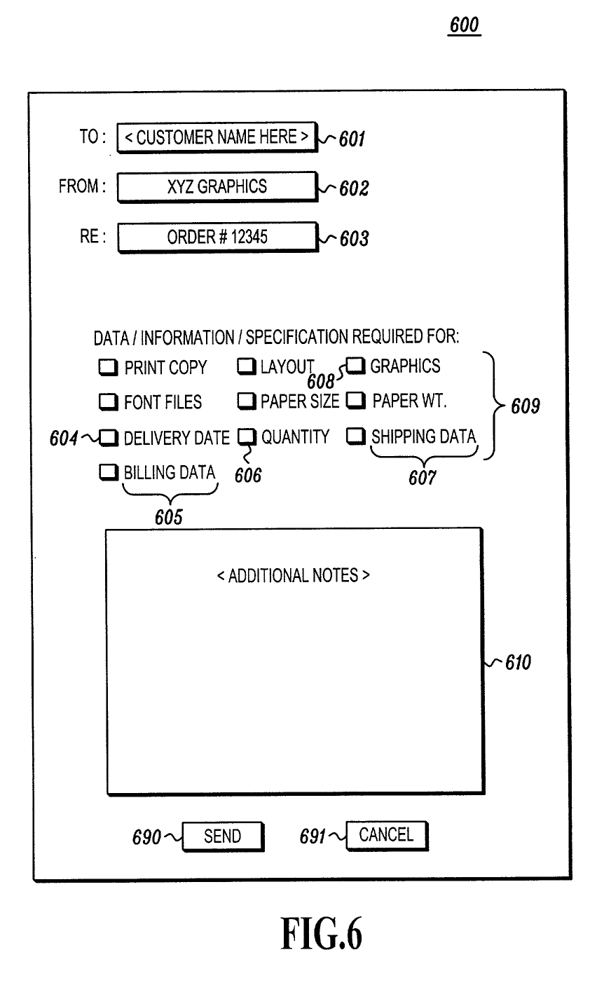

FIG. 6 shows an exemplary embodiment of a user-interface 600 by which the print service provider can generate a secure, rich-format e-mail message for transmission to the customer. (Those of ordinary skill in the art will appreciate that an e-mail message consists of one or more data packets, such as Ethernet packets, containing data that can be read by an application package so as to present intelligible information onto the screen of a personal computer. The composition and transmission of e-mail is known to those of ordinary skill in the art and omitted for brevity.) In a preferred embodiment, the data of a secure, rich-format e-mail message 600 originates from the print brokering system controller 28, however, alternate embodiments generate secure, rich-format e-mail messages at the print provider 22 through the print brokering system. As used herein “secure e-mail message” refers to either a truly secure e-mail (e.g. an encrypted e-mail) or, a hyper link to a secure web page through which messages can be exchanged securely. Encrypted or “secure” e-mail and secure web pages are known to those of skill in the art.

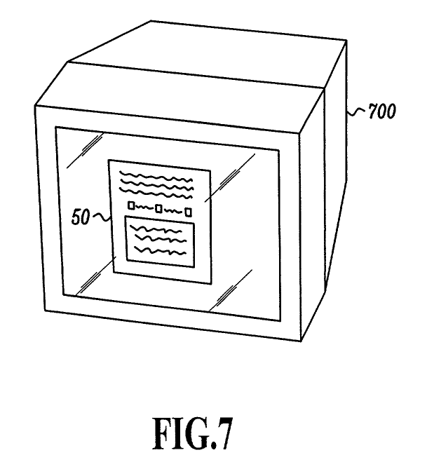

FIG. 7 depicts a representation of a computer monitor 700. It can be seen in FIG. 7 that the user-interface of a secure, rich-format e-mail message shown in FIG. 6 can be seen on the monitor's screen. Various input fields 50 of the secure, rich-format e-mail message are also displayed on the monitor 700 enabling the input fields 50 to be selected (i.e., activated) using an input device such as a mouse, a computer keyboard, light pen or other equivalent device.

As used herein, the term “secure, rich-format e-mail message” refers to or describes an e-mail message having a well-defined and pre-determined format. The designation of an e-mail message as being “rich format” also refers to the pre-packaged “chunks” of information that are attached to the message (to be transmitted to the recipient) by either the print brokering system controller 28, the print provider's computer 22 or the print provider interface 26, by attaching either message text or a hyper link to a web page whereat additional information is kept. The “rich format” message facilitates the transmission of information by a user by the user “clicking” at (or on) one or more sensitized areas, such as those identified in FIG. 6 by reference numerals 604, 606, 608 thereby activating a mouse pointer, light pen or other pointing device to select the one or more sensitized areas. Such areas are preferably displayed on a PC screen adjacent to ASCII character strings 605, 607, the text of which denominates the information that will be requested from the e-mail recipient by selecting the particular sensitized areas 604, 606, 608. The term “rich-format” means that the message that is created will include within it, hyper links to web sites so as to allow a recipient of the e-mail to directly provide missing or required information that was identified by the e-mail sender by the sender's selection of one or more items listed or shown in the interface 600.

A print service providers' computers and print service customer's computers, both of which act as clients to the print brokering system controller 28, preferably send and receive secure, rich-format e-mail messages 600 via the system controller 28. Notwithstanding the inability of the print provider's computer and the customer's computers to communicate securely directly, they are nevertheless indirectly coupled together via their mutual communications with the print brokering system controller 28, which initiates the assignment/delegation of print jobs 12.

The secure, rich-format e-mail message 600 is considered “secure” because of encryption (not shown, but well-known to those of ordinary skill in the art of data encryption) performed by the brokering system controller 28 prior to the e-mail's transmission to the print provider 16. Digital certificates can be used to encrypt and decrypt e-mail messages as well. Digital certificates to encrypt messages are known in the art. Encryption programs, such as “PGP” rely upon digital certificates, which are also known as “encryption keys,” to encrypt and decrypt messages. In using digital certificates, proprietary communications between the customer and entities with which the customer transacts its printing business over the Internet is protected from surreptitious interception, regardless of how likely or unlikely the occurrence of such an interception might be.

A secure, rich-format e-mail message 600 appears in FIG. 6 as having a “to” address field 601, a “from” address field 602 and further having subject line 603. In the example depicted in FIG. 6, the “to” field is the name of a customer to which the message is addressed. As set forth above, the message 600 is considered to be a “rich-format” message because the message that is created using the interface 600 shown in FIG. 6, will include within it, hyper links to web sites so as to allow a recipient of the e-mail to directly provide missing or required information that was identified by the e-mail sender by the sender's selection of one or more items listed or shown in the interface 600. In other words, hyper links are included in the message sent to a recipient and can be used by the e-mail recipient to access a web site whereat information required by the sender, can be provided.

Some examples of the informational message items that can be easily selected by “clicking” a sensitized area 604, 606, 608 include a message requesting delivery date (604) or asking the customer to specify a number of copies to be made (606) or requesting information on graphics to be included (608) in a particular print job. A particular print job is identified by the reference provided in the “re” line 603, such as the “order number 12345.” By providing pre-packaged, informational requests in the form of selectable message boxes 604, 606, 608, the secure, rich-format e-mail message simplifies and expedites the informational exchange between a print service provider and its customer. Additional text or other ASCII strings can be entered free form into the dialog window 610.

At the bottom of FIG. 6 are two softkeys or sensitized screen area “buttons” 690 and 691 the functions of which are to either send the message or cancel its transmission. When the “send” button 690 is activated, the information entered by the print provider is HTTP-posted to the print brokering system controller. That information is used by the print brokering system controller to programmatically a rich-format e-mail message to be sent directly to the customer using standard e-mail protocols.

In an alternate embodiment, a rich-format e-mail message can be automatically generated and sent if the print provider 22 identifies certain information as missing and required. An example of such an autonomous response to a print job 12 brokered to a print provider 22 is the determination by a print provider 22 that font files for a print job 12 are required but missing. The e-mail received by the customer will include one or more links to one or more secure interfaces to enable the upload of necessary font files from the customer.

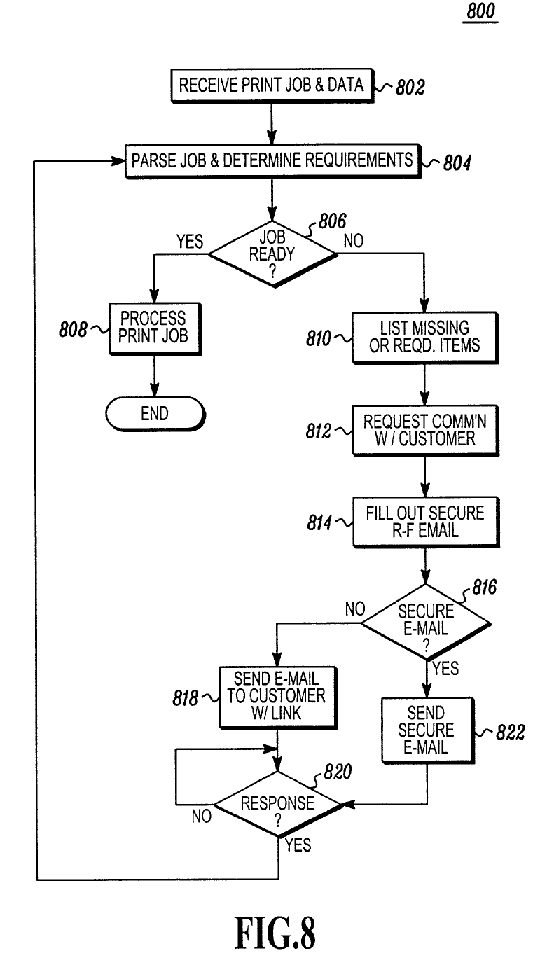

FIG. 8 depicts the steps of a method 800 by which a secure, rich-format message related to a specific print job is initiated and transmitted by a print provider's computer. In step 802, one or more data files that comprise a print job 12 (which are sent from either the customer 14 or the print brokering system controller 28) are received at a print provider's 22 computer. The print job and data files (identified by reference numeral 12) received in step 802 is parsed in step 804 by the print providers' 22 computer to identify print job requirements, such as required font files, paper size and weight, graphics, layout and the like.

After the print job requirements are identified in step 804 from the print job data files, in step 806, the print provider 22 determines whether it has all of the requisite resources (e.g., data files, print files, customer information, finishing instructions) to complete the print job 12 as well as determining whether any other information might be required. If a determination is made that the print job 12 can be completed, program control proceeds to step 808 where the print job is performed and the method can end.

The print job completion can be notified to the customer via an e-mail message, phone call or other message to the customer. Alternatively, a print job output file can be sent back to the customer via the network 30 so as to enable a customer to print a job locally, if by chance the customer has the appropriate printing equipment.

On the other hand, if a determination is made in step 806 that communication with the customer 14 is required, a list of missing and/or required items is compiled in step 810.

In step 812, the print service providers' computer requests a communication session with the customer, typically by activating a secure, rich-format e-mail application program. In step 814, the secure, rich-format e-mail message is prepared using a message interface 600 such as that describe above. Using the interface 600 depicted in FIG. 6, various fields can be selected by which certain types of hyper links to web sites whereat certain information (identified in steps 806 and 810) can be provided or obtained.

In step 816, a determination is made whether secure e-mail (i.e., encrypted e-mail) is available. If so, the rich-format e-mail is encrypted and transmitted in step 822. If secure e-mail is not available, in step 818 the customer is sent an e-mail with a link to a secure web site whereat the information that was provided in step 814 can be transmitted to the customer via a secure hyper text transfer protocol.

After the link to a secure web site is sent to the customer in step 818, (or the secure e-mail is sent in step 822) the method waits a predetermined time for a response from the customer in step 820. A response can take the form of an e-mail from the customer or a HTTP message returned via the web site that was identified to the customer in step 818. (Not shown in FIG. 8 is the abortion of the delay loop at step 820, which as those skilled in the art will recognize, is required to prevent the program from hanging up the print provider's computer indefinitely.) Program control will wait at step 820 a reasonable length of time before aborting the wait loop associated with step 820. The loop counter or timer required to exit step 820 is not shown for clarity. When a response to step 820 is received, program control returns to step 804 where the process begins again. If no response is received at step 820, the response failure will trigger a notification to the print provider 22. Such notification could cause: termination of a print job 12, or re-attempting e-mail transmission to the customer at a later time or, contacting the customer by some other media, such as by telephone, fax or other means.

When the secure, rich-format message is completed in step 814, the message is transmitted to the customer in step 816 via either the controller 28 or via some other pathway through the Internet 30. When a response is received from a customer in step 820, the print job can be performed, preferably to completion.

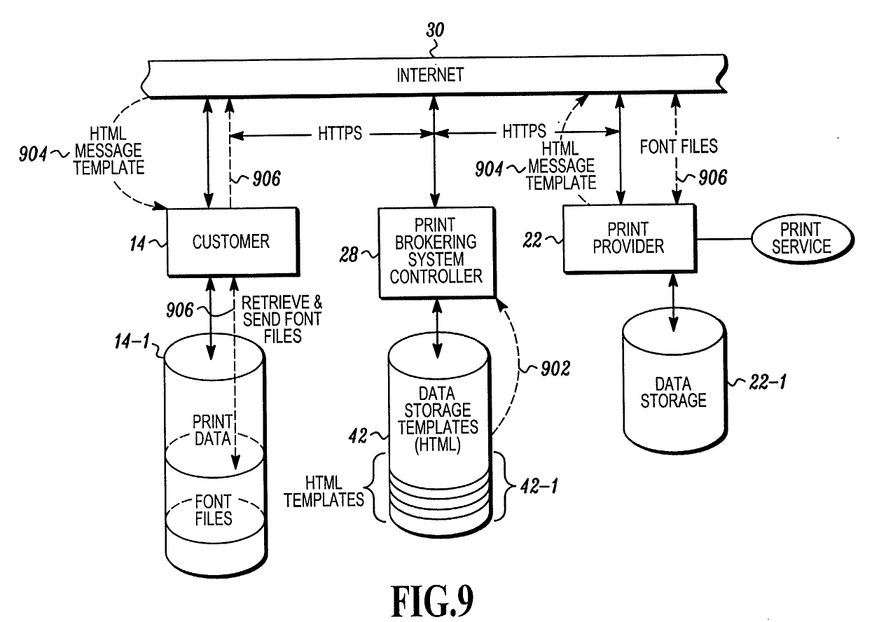

FIG. 9 depicts an example of how HTML forms can be used to communicate between a print provider 22 and a customer 14 (shown in FIG. 1). A print provider 22 to which a print job has been sent, (and which determines, for instance, that font files for the print job 12 are required but were not received with the print job) retrieves from the print brokering system controller 28, an HTML message template 902 from data storage 42 where HTML templates are stored 42-1.

In the example, because the print provider 22 determined that font files are missing from the print job it received and that the font files are required to perform the print job, the print provider needs to convey it's need for the font files to the customer 14. In order to do so, an HTML form that includes within it, a request for the font files, is retrieved from among several such forms (not shown) stored in the storage device 42-1.

Once the HTML message template 902 is retrieved by the print brokering system controller 28, it forwards the HTML form to the print provider 22 whereat, additional data or messages can be appended to it and transmitted as an HTTPS message 904 for transfer via the Internet 30 to the customer 14. When the customer receives the HTML form 904, it can extract information from the form 904 by which the customer 14 learns that font files are needed to perform the customer's print job.

In response to the HTML message 904, the customer 14 retrieves from data storage 14-1 the requisite font files 906. For purposes of this example, the required font files 906 can be provided to the print provider 22 in one of two ways. The font files 906 can be sent to the print provider 22 from the customer, such as by the Internet 30, or, the customer 14 can provide to the print provider, a link or address of another source (e.g. a web page or the print brokering system controller 28) where the font files can be found and downloaded by the print provider 22. For purposes of this disclosure and claim construction, communicating via a rich-format e-mail, (secure or unsecure) and communicating via an HTML form are considered to be equivalent techniques. Other HTML templates can be created and used to quickly request information, data as well as to quickly provide information to the customer.

Templates can be generated regarding any sort of issue or aspect of a print job. Indeed, HTML templates (and for that matter, secure, rich-format e-mail messages) are contemplated wherein a customer's contact information is presented in a meaningful way as part of the HTML message.

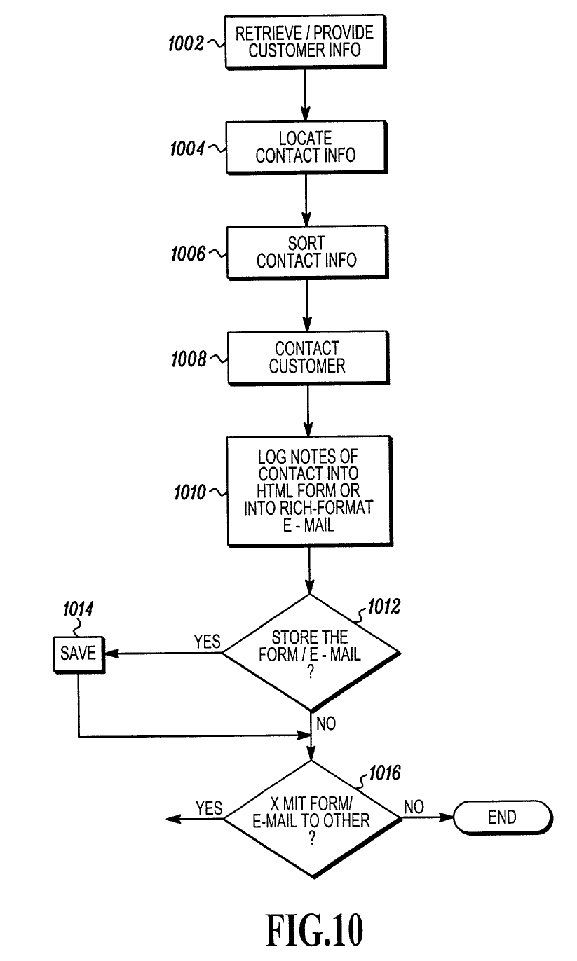

FIG. 10 displays a flow chart of method steps by which customer contact information is sorted (by either the print brokering system controller 28 or the print provider 22), presented for display (by either the print brokering system controller 28 or the print provider 22) as part of an HTML form (or rich-format e-mail message) and stored with notes and memoranda of a customer contact.

In step 1002, customer data, including print job data and customer contact data (e.g., customer number, customer name, customer mailing or postal address, customer phone number, customer e-mail address), is retrieved from storage. In the case of the print brokering system controller 28, such data can be retrieved from it's data storage 42. In the case of the print provider 22, such data can be retrieved from it's local storage 22-1. (In instances where the print brokering system controller 28 is part of a distributed network of computers or when the print provider 22 is part of a network, or when such processors run different computing tasks in a multi-tasking operating system, data base contents might be managed by a data base manager, implemented in either hardware or software. In such instances, data from storage is sometimes considered as being “provided” to another computer.)

In step 1004, customer contact information, (which is presumably provided by the customer 14 upon initiation of the customer's print job request) is located from the customer-provided data retrieved from storage in step 1002, which would include data pertinent to the print job. As set forth above, customer contact data can include, but is not limited to, telephone numbers or e-mail addresses at which the customer 14 can be reached.

In step 1006, customer contact information can be sorted according to different criteria. The customer contact data can be sorted according to a time of day at which the customer can be reached at a particular number or address. In addition to phone numbers and e-mail addresses, business or residence addresses can be sorted as well. Contact data for different customers can also be sorted in step 1006 according to criteria such as the customer's job priority (e.g., dollar value) or size; customer name, address or any other criteria by which customers might be characterized or identified.

In step 1008, the customer is contacted, by telephone for example and in step 1010, notes and other memoranda of the contact is logged into an HTML form (or rich-format e-mail). At any time during or after a customer contact, the HTML form (or rich-format e-mail) can be stored, if desired, at decision block 1012 and step 1014. Alternatively, the HTML form (or rich-format e-mail) can be transmitted to the customer or to another computer in step 1016.

In yet another embodiment, of an Internet-based print brokering system and method, communications between a print provider 22 and a customer can be expanded to include voice communications between the print provider 22 and the customer 14, which is carried between them via the Internet. For purposes of claim construction, voice communications are also considered to be “rich format” messages and at least equivalent to secure e-mail inasmuch as they are a compact and efficient form of information transmission.

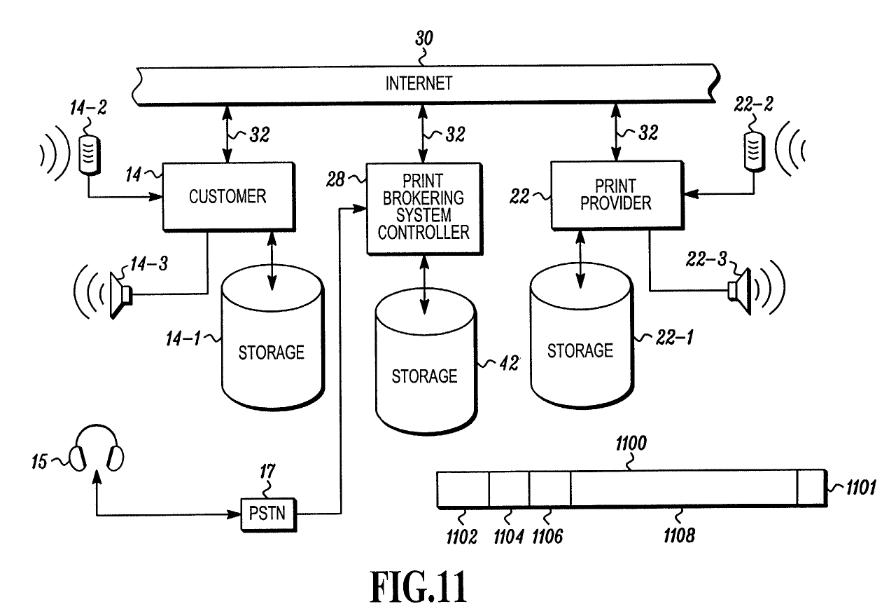

FIG. 11 depicts a print provider's computer 22 to which there is coupled a microphone 22-2 and a speaker 22-3. The print provider's computer 22 is coupled to the Internet 30 via a link 32. A microphone 14-2 and a speaker 14-3 are coupled to the customer's computer 14, using devices such as the well-known and nearly ubiquitous “sound card” accessories through which audio signals are passed to and from a computer. The customer's computer 14 is also coupled to the Internet 30 via a data link 32, such as a dial-up connection, cable modem, or T-1 data link. Because both the customer 14 and the print provider 22 are operatively coupled together via the Internet 30, voice communications can be exchanged between them via the Internet 30.

In FIG. 11, voice signals received at either microphone 22-2 or 14-2 are converted to digital data and packaged for transfer via a data network, typically by converting the analog voice signals into data packets 1108 such as those used with Ethernet-type data packets 1100, each of which includes several different data fields, each of which represents different information. Data fields near the head or start of a packet 1100, such as routing addresses 1102, 1104 and 1106 determine how the packet 1100 will find it's way to a computer whereat the speaker's voice is reconstructed and broadcast on a speaker 22-3 or 14-3. A checksum or error correction field 1101, which is usually located near the end of the packet 1100 is usually used to insure that a packet 1100 is delivered intact.

Because the voice signals of a VOIP communication are digitized, the entire conversation can be encrypted and decrypted for network 30 transmission as well as stored for later retrieval. In an alternate embodiment of an Internet print brokering system and method, a voice conversation between a customer and a print provider that relates to a print job can be stored along with other data and information related to the print job that was the subject of a VOIP telephone call.

Data storage device 14-1 coupled to the customer's computer 14 can store a VOIP conversation as can storage device 22-1, which is coupled to the print provider's computer 22. The print brokering system computer 28 receives the data packets of the VOIP conversation.

In addition to storing all of a VOIP conversation, selected parts of a VOIP conversation can be stored, in part, to reduce data storage requirements. Similarly, the date, time and duration of a call can be recorded in storage as well as the phone number or other indicia of who the parties to the call were. A print job number can be stored and used to index the conversation and all data associated with the call. Voice recognition software running on computer 28 can also transcribe the conversation and print or store the transcription (on disk or magnetic tape for example) for subsequent documentation of the call. In an alternate embodiment, wherein a customer does not have VOIP, the print brokering system controller 28 can dial the customer's telephone 15 via the public switched telephone network 17 or another telecommunications service (e.g. cellular) by which communications can be established between the print provider 22 and the customer 14, at least partially using VOIP between the print brokering system controller 28 and the print provider 22.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

While the embodiments discussed above contemplate usage with an on-line print brokering system, the methods and apparatus' described above are equally useful with virtually any on-line merchandising business. Accordingly, the disclosed subject matter should be considered to be equally useful with on-line sales of goods or services in general and not necessarily limited to on-line print brokering and as such, the claims should not be considered to be limited to an on-line print brokering system.

What is claimed is:

1. An on-line brokering method comprising the steps of:
receiving at an order fulfillment computer, an order comprised of a request for either goods or services;
providing at said order fulfillment computer, a rich-format message that is to be sent to the source of said request for the goods or services; and
sending via a data network, said rich-formatted message from said order fulfillment computer to the source of said request for goods or services.

2. The method of claim 1 wherein said step of providing information into a rich-formatted message includes the step of providing information into a rich-formatted message is at least one of: a secure e-mail message; a voice-over-IP message.

3. The method of claim 1 wherein said step of providing a rich-format message includes the step of providing a message encrypted using a digital certificate.

4. The method of claim 1 wherein said step of providing a rich-format message includes the step of providing a rich-format e-mail that is encrypted.

5. The method of claim 1 wherein said step of generating a rich-formatted e-mail message includes the steps of generating and sending at least one hyper text mark-up language (HTML) form.

6. The method of claim 1 wherein said step of generating a rich-formatted e-mail message includes the step of attaching to said rich-formatted e-mail message, at least one hyper text mark-up language (HTML) form that includes predetermined information about said request for a print job.

7. The method of claim 1 wherein said step of generating a rich-formatted e-mail message includes the step of including a hyperlink to a web site.

8. An on-line brokering method of fulfilling print orders via a data network comprising the steps of:
receiving at a print order fulfillment computer from a print brokering computer, a print order comprised of a request for a print job;
providing at said print order fulfillment computer, a secure, rich-format e-mail message that is to be sent to the source of said request for a print job; and
sending via a data network, said secure, rich-formatted e-mail message from said print order fulfillment computer to the source of said request for a print job.

9. The method of claim 8 wherein said step of sending a rich-format message includes the step of providing a message encrypted using a digital certificate.

10. The method of claim 8 wherein said step of sending a rich-formatted e-mail message includes the step of attaching to said rich-formatted e-mail message, at least one hyper text mark-up language (HTML) form that includes predetermined information about said request for a print job.

11. A method of fulfilling print jobs via a data network comprising the steps of:
receiving at a print service brokering computer via a data network, a print order comprised of a request for a print job; and
sending said print order to a print order fulfillment computer via said data network, including sending to said print order fulfillment computer, a rich-formatted e-mail message.

12. The method of claim 11 wherein said step of sending a rich-format message includes the step of providing a message encrypted using a digital certificate.

13. The method of claim 11 wherein said step of sending a rich-formatted e-mail message includes the step of attaching to said rich-formatted e-mail message, at least one hyper text mark-up language (HTML) form that includes predetermined information about said request for a print job.

14. A method of fulfilling print jobs via a data network comprising the steps of:
sending to a print order fulfillment computer, a print job, said print job being received from a print services customer's computer via a data network;
receiving from said print order fulfillment computer, a rich-format e-mail message; and
sending via a data network, said rich-formatted e-mail message to said print order purchaser computer.

15. The method of claim 14, wherein said second sending step is performed by said print order fulfillment computer.

16. The method of claim 14, wherein said receiving step includes the step of receiving a message encrypted by way of a digital certificate.

17. A method of fulfilling print jobs via a data network comprising the steps of:
receiving at a print order fulfillment computer, a print order comprised of a request for a print job;
assigning an identifier to said print order; and
sending said identified to a print order fulfillment computer.

18. The method of claim 17 wherein said sending step includes sending a rich-format e-mail that is encrypted.

19. The method of claim 17 wherein said sending step includes generating and sending at least one hyper text mark-up language (HTML) form.

20. A system for brokering print services on-line comprised of:
a print order fulfillment computer, operatively coupled to a data network;
a print brokering computer, operatively coupled to said data network and capable of communicating with said print order fulfillment computer; and
a print services customer's computer, operatively coupled to said data network and capable of communicating with said print order fulfillment computer via said data network.
